(19) United States
(12) Patent Application Publication
(10) Pub. No.: US 2016/0091951 A1
(43) Pub. Date: Mar. 31, 2016

(54) Systems and Methods for Power Reduced Data Decoder Scheduling

(71) Applicant: LSI Corporation, San Jose, CA (US)

(72) Inventors: Yang Han, Sunnyvale, CA (US); Qi Zuo, Milpitas, CA (US); Dan Liu, Shanghai (CN); Shaohua Yang, San Jose, CA (US)

(21) Appl. No.: 14/499,271

(22) Filed: Sep. 29, 2014

(51) Int. Cl. G06F 1/32; G06F 11/10

(52) U.S. Cl. CPC G06F 1/329; G06F 11/10; G06F 1/3296

(57) ABSTRACT

The present inventions are related to systems and methods for data processing, and more particularly to systems and methods for scheduling in a data decoder.

### FIELD OF THE INVENTION

The present inventions are related to systems and methods for data processing, and more particularly to systems and methods for scheduling in a data decoder.

### BACKGROUND

Various data storage systems have been developed that include data decoding circuitry. Such data decoding circuitry generally schedules the processing of elements of a decoded message based upon a first in, first out scheduling. In some cases, such an approach to scheduling can use significant power.

Hence, for at least the aforementioned reasons, there exists a need in the art for advanced systems and methods for scheduling operations in a data processing system.

### SUMMARY

The present inventions are related to systems and methods for data processing, and more particularly to systems and methods for scheduling in a data decoder.

Various embodiments provide systems for decoding a data set that includes a layered data decoder circuit and a scheduler circuit. The layered data decoder circuit is operable to apply a data decoding algorithm to a data input to yield a decoded output. The data input includes a group of input elements. The scheduler circuit is operable to: identify layer based connections between individual elements of the group of input elements; assemble a first subset of the group of input elements that share a first set of layer based connections to yield a first processing group; assemble a second subset of the group of input elements that share a second set of layer based connections to yield a second processing group; and provide a layered processing order. The layered processing order includes the first processing group being processed by the layered data decoder circuit before the second processing group is processed by the layered data decoder circuit

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment or one embodiment, and may be included in more than one embodiment. Importantly, such phases do not necessarily refer to the same embodiment. Many other embodiments of the invention will become more fully apparent from the following detailed description, the appended claims and the accompanying drawings.

### BRIEF DESCRIPTION OF THE FIGURES

A further understanding of the various embodiments may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage device having power reduced data decoder scheduling in accordance with various embodiments;

FIG. 2 depicts a data transmission device including a receiver having power reduced data decoder scheduling in accordance with one or more embodiments;

FIG. 3 shows a solid state memory circuit including a data processing circuit having power reduced data decoder scheduling in accordance with some embodiments;

FIG. 4 depicts a data processing system including a having power reduced data decoder scheduling circuit in accordance with various embodiments;

FIG. 5 depicts a block diagram of a multi-level LDPC layer decoder with layer re-ordering in accordance with various embodiments;

FIG. 6 is a timing diagram showing overlapping data decoder processing that may be used in relation to one or more embodiments;

FIG. 7 is a flow diagram showing a method in accordance with one or more embodiments for limiting layer switching as part of a data decoding algorithm;

FIG. 8 shows an example element re-ordering in accordance with some embodiments;

FIG. 9 is a flow diagram showing another method in accordance with one or more embodiments for limiting layer switching as part of a data decoding algorithm; and

FIGS. 10a-10b shows an example element re-ordering in accordance with various embodiments.

### DETAILED DESCRIPTION OF SOME EMBODIMENTS

The present inventions are related to systems and methods for data processing, and more particularly to systems and methods for synchronizing operations in a data storage system.

Various embodiments provide systems for decoding a data set that includes a layered data decoder circuit and a scheduler circuit. The layered data decoder circuit is operable to apply a data decoding algorithm to a data input to yield a decoded output. The data input includes a group of input elements. The scheduler circuit is operable to: identify layer based connections between individual elements of the group of input elements; assemble a first subset of the group of input elements that share a first set of layer based connections to yield a first processing group; assemble a second subset of the group of input elements that share a second set of layer based connections to yield a second processing group; and provide a layered processing order. The layered processing order includes the first processing group being processed by the layered data decoder circuit before the second processing group is processed by the layered data decoder circuit. In particular instances of the aforementioned embodiments, the system is implemented as part of an integrated circuit.

In some instances of the aforementioned embodiments, the layered processing order limits switching between layers during application of the data decoding algorithm. In particular cases, limiting switching between layers during application of the data decoding algorithm reduces power consumption by the layered data decoder circuit. In one or more instances of the aforementioned embodiments, the group of input elements is a group of circulants, the first subset of the group of input elements is a first subset of the group of circulants, and the second subset of the group of input elements is a second subset of the group of circulants. In various cases, the first subset of the group of circulants exhibits connections to a first previously processed layer, and the second subset of the group of circulants exhibits connections to a second previously processed layer. In other cases, the first subset of the group of circulants does not exhibit any connections to a previously processed layer, and the second subset of the group of circulants exhibits connections to the previously processed layer.

In one or more instances of the aforementioned embodiments, the system is implemented as part of a device selected from a group consisting of: a storage device, and a communication device. In various instances of the aforementioned embodiments, the layered data decoder circuit includes a variable node processor, and a check node processor. In some instances of the aforementioned embodiments, the data decoding algorithm is a low density parity check decoding algorithm.

Other embodiments provide methods for decoding a data set that includes: providing a layered data decoder circuit operable to apply a data decoding algorithm to a data input to yield a decoded output, where the data input includes a group of input elements; identifying layer based connections between individual elements of the group of input elements; assembling a first subset of the group of input elements that share a first set of layer based connections to yield a first processing group; assembling a second subset of the group of input elements that share a second set of layer based connections to yield a second processing group; and applying the data decoding algorithm by the data decoder circuit such that the first processing group is processed by the layered data decoder circuit before the second processing group is processed by the layered data decoder circuit.

In particular instances of the aforementioned embodiments, applying the data decoding algorithm by the data decoder circuit such that the first processing group is processed by the layered data decoder circuit before the second processing group is processed by the layered data decoder circuit limits switching between layers during application of the data decoding algorithm. In some cases, limiting switching between layers during application of the data decoding algorithm reduces power consumption by the layered data decoder circuit.

In various instances of the aforementioned embodiments, the group of input elements is a group of circulants, the first subset of the group of input elements is a first subset of the group of circulants, and the second subset of the group of input elements is a second subset of the group of circulants. In some cases, the first subset of the group of circulants exhibits connections to a first previously processed layer, and the second subset of the group of circulants exhibits connections to a second previously processed layer. In other cases, the first subset of the group of circulants does not exhibit any connections to a previously processed layer, and the second subset of the group of circulants exhibits connections to the previously processed layer.

Yet other embodiments provide storage devices that include: a storage medium; a data detector circuit operable to apply a data detection algorithm to a data input to yield a detected output, where the data input is derived from information accessed from the storage medium; a layered data decoder circuit operable to apply a data decoding algorithm to a data input to yield a decoded output, where the data input includes a group of input elements; and a scheduler circuit operable to: identify layer based connections between individual elements of the group of input elements; assemble a first subset of the group of input elements that share a first set of layer based connections to yield a first processing group; assemble a second subset of the group of input elements that share a second set of layer based connections to yield a second processing group; and provide a layered processing order, wherein the layered processing order includes the first processing group being processed by the layered data decoder circuit before the second processing group is processed by the layered data decoder circuit.

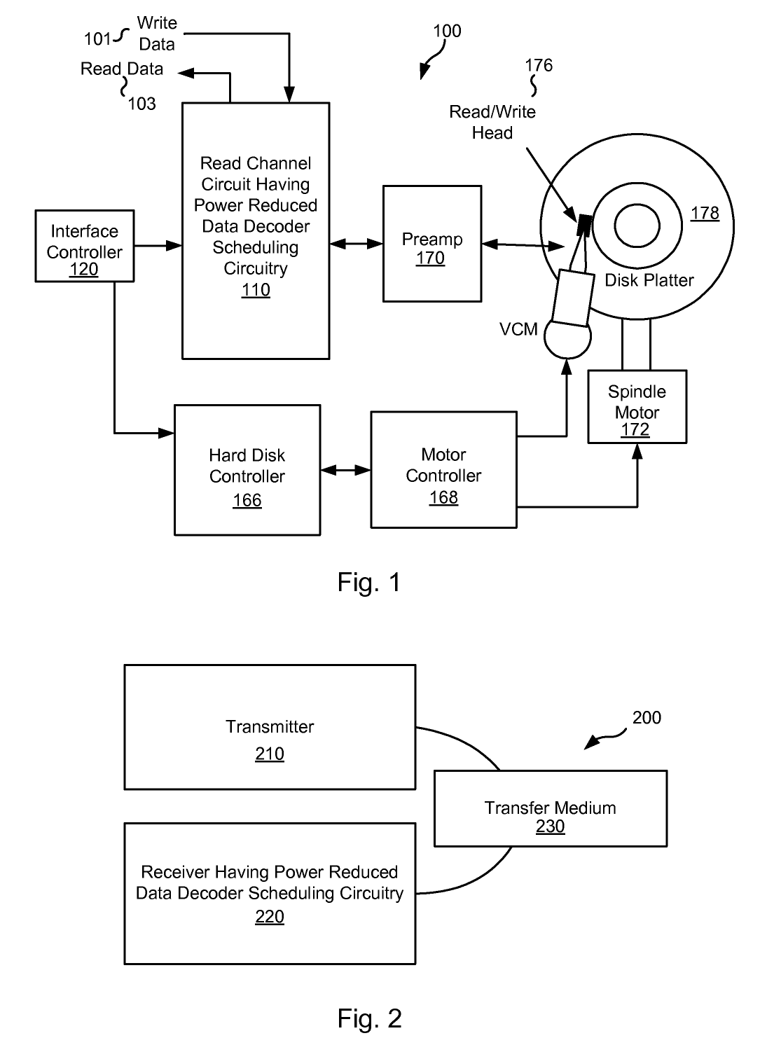

Turning to FIG. 1, a storage system 100 is shown that includes a read channel circuit 110 having power reduced data decoder scheduling circuitry in accordance with one or more embodiments. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178, and interacts with a host controller (not shown). The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head 176 is accurately positioned by motor controller 168 over a desired data track on disk platter 178. Motor controller 168 both positions read/write head 176 in relation to disk platter 178 and drives spindle motor 172 by moving read/write head assembly 176 to the proper data track on disk platter 178 under the direction of hard disk controller 166. Spindle motor 172 spins disk platter 178 at a determined spin rate (RPMs). Once read/write head 176 is positioned adjacent the proper data track, magnetic signals representing data on disk platter 178 are sensed by read/write head 176 as disk platter 178 is rotated by spindle motor 172. The sensed magnetic signals are provided as a continuous, minute analog signal representative of the magnetic data on disk platter 178. This minute analog signal is transferred from read/write head 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

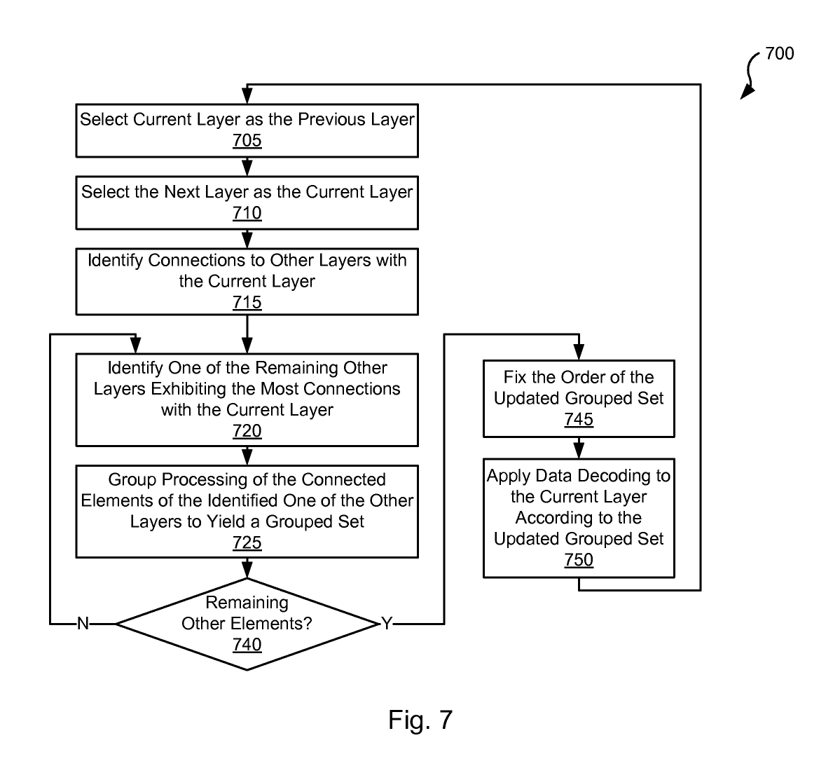

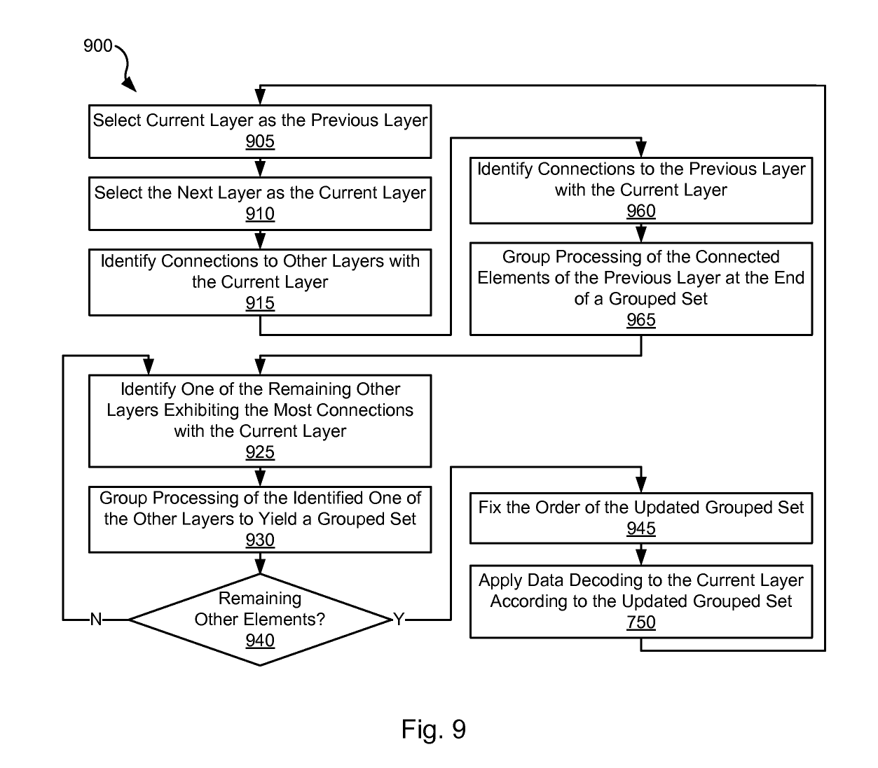

In operation, data accessed from disk platter 178 is processed using a layered decoding algorithm. The layered decoding algorithm utilizes an element scheduling algorithm that processes elements of each layer of a data set in an order that reduces power used by read channel circuit 110 by scheduling an order in which data elements of a current layer are processed to reduce the number of switches between other layers maintained in a decoder memory. The data processing including layered decoding may be implemented similar to that discussed below in relation to FIG. 4. Further, the data processing may be completed using a method such as that discussed in relation to FIG. 7 or FIG. 9.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

Turning to FIG. 2, a data transmission system 200 including a receiver 220 having power reduced data decoder scheduling circuitry in accordance with one or more embodiments. A transmitter 210 transmits encoded data via a transfer medium 230 as is known in the art. The encoded data is received from transfer medium 230 by receiver 220.

In operation, data received via transfer medium 230 is processed by receiver 220 using a layered decoding algorithm. The layered decoding algorithm utilizes an element scheduling algorithm that processes elements of each layer of a data set in an order that reduces power used by read channel circuit 110 by scheduling an order in which data elements of a current layer are processed to reduce the number of switches between other layers maintained in a decoder memory. The data processing including layered decoding may be implemented similar to that discussed below in relation to FIG. 4. Further, the data processing may be completed using a method such as that discussed in relation to FIG. 7 or FIG. 9.

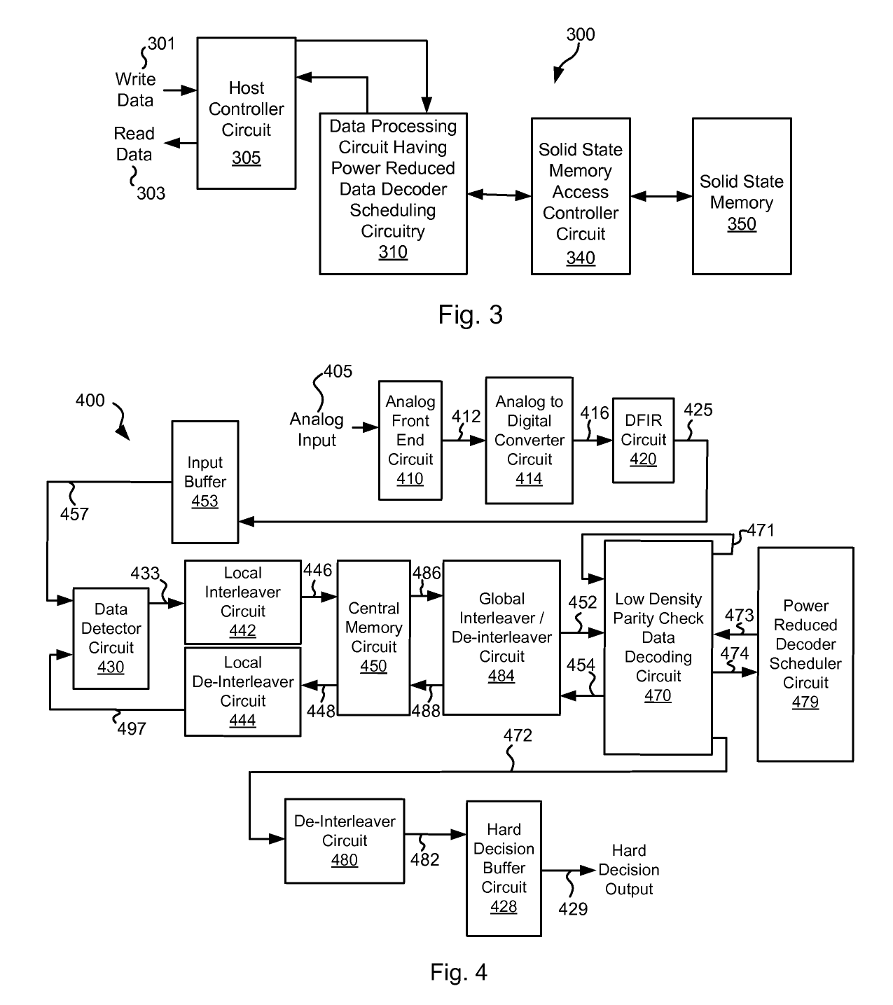

Turning to FIG. 3, another storage system 300 is shown that includes a data processing circuit 310 having power reduced data decoder scheduling circuitry in accordance with one or more embodiments. A host controller circuit 305 receives data to be stored (i.e., write data 301). Solid state memory access controller circuit 340 may be any circuit known in the art that is capable of controlling access to and from a solid state memory. Solid state memory access controller circuit 340 formats the received encoded data for transfer to a solid state memory 350. Solid state memory 350 may be any solid state memory known in the art. In some embodiments, solid state memory 350 is a flash memory. Later, when the previously written data is to be accessed from solid state memory 350, solid state memory access controller circuit 340 requests the data from solid state memory 350 and provides the requested data to data processing circuit 310. In turn, data processing circuit 310 processes the requested data using a layered decoding algorithm. In operation, data received from solid state memory 350 is processed using a layered decoding algorithm. The layered decoding algorithm utilizes an element scheduling algorithm that processes elements of each layer of a data set in an order that reduces power used by data processing circuit 310 by scheduling an order in which data elements of a current layer are processed to reduce the number of switches between other layers maintained in a decoder memory. The data processing including layered decoding may be implemented similar to that discussed below in relation to FIG. 4. Further, the data processing may be completed using a method such as that discussed in relation to FIG. 7 or FIG. 9.

Turning to FIG. 4, a data processing system 400 including a power reduced decoder scheduler circuit 479 in part governing operation of a data decoding circuit 470 in accordance with various embodiments. Data processing system 400 includes an analog front end circuit 410 that receives an analog signal 405. Analog front end circuit 410 processes analog signal 405 and provides a processed analog signal 412 to an analog to digital converter circuit 414. Analog front end circuit 410 may include, but is not limited to, an analog filter and an amplifier circuit as are known in the art. Based upon the disclosure provided herein, one of ordinary skill in the art will recognize a variety of circuitry that may be included as part of analog front end circuit 410. In some cases, analog signal 405 is derived from a read/write head assembly (not shown) that is disposed in relation to a storage medium (not shown). In other cases, analog signal 405 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 405 may be derived.

Analog to digital converter circuit 414 converts processed analog signal 412 into a corresponding series of digital samples 416. Analog to digital converter circuit 414 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments. Digital samples 416 are provided to an equalizer circuit 420. Equalizer circuit 420 applies an equalization algorithm to digital samples 416 to yield an equalized output 425. In some embodiments, equalizer circuit 420 is a digital finite impulse response filter circuit as are known in the art. It may be possible that equalized output 425 may be received directly from a storage device in, for example, a solid state storage system. In such cases, analog front end circuit 410, analog to digital converter circuit 414 and equalizer circuit 420 may be eliminated where the data is received as a digital data input. Equalized output 425 is stored to an input buffer 453 that includes sufficient memory to maintain a number of codewords until processing of that codeword is completed through a data detector circuit 430 and low density parity check (LDPC) decoding circuit 470 including, where warranted, multiple global iterations (passes through both data detector circuit 430 and LDPC decoding circuit 470) and/or local iterations (passes through LDPC decoding circuit 470 during a given global iteration). An output 457 is provided to data detector circuit 430.

Data detector circuit 430 may be a single data detector circuit or may be two or more data detector circuits operating in parallel on different codewords. Whether it is a single data detector circuit or a number of data detector circuits operating in parallel, data detector circuit 430 is operable to apply a data detection algorithm to a received codeword or data set. In some embodiments, data detector circuit 430 is a Viterbi algorithm data detector circuit as are known in the art. In other embodiments, data detector circuit 430 is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments. In some cases, one data detector circuit included in data detector circuit 430 is used to apply the data detection algorithm to the received codeword for a first global iteration applied to the received codeword, and another data detector circuit included in data detector circuit 430 is operable apply the data detection algorithm to the received codeword guided by a decoded output accessed from a central memory circuit 450 on subsequent global iterations.

Upon completion of application of the data detection algorithm to the received codeword on the first global iteration, data detector circuit 430 provides a detector output 433. Detector output 433 includes soft data. As used herein, the phrase “soft data” is used in its broadest sense to mean reliability data with each instance of the reliability data indicating a likelihood that a corresponding bit position or group of bit positions has been correctly detected. In some embodiments, the soft data or reliability data is log likelihood ratio data as is known in the art. Detector output 433 is provided to a local interleaver circuit 442. Local interleaver circuit 442 is operable to shuffle sub-portions (i.e., local chunks) of the data set included as detected output and provides an interleaved codeword 446 that is stored to central memory circuit 450. Local interleaver circuit 442 may be any circuit known in the art that is capable of shuffling data sets to yield a re-arranged data set. Interleaved codeword 446 is stored to central memory circuit 450.

Once LDPC decoding circuit 470 is available, a previously stored interleaved codeword 446 is accessed from central memory circuit 450 as a stored codeword 486 and globally interleaved by a global interleaver/de-interleaver circuit 484. Global interleaver/de-interleaver circuit 484 may be any circuit known in the art that is capable of globally rearranging codewords. Global interleaver/De-interleaver circuit 484 provides a decoder input 452 into LDPC decoding circuit 470. LDPC decoding circuit 470 applies one or more iterations or a layered data decoding algorithm to decoder input 452 to yield a decoded output 471. In cases where another local iteration (i.e., another pass through LDPC decoding circuit 470) is desired (i.e., decoding failed to converge and more local iterations are allowed), LDPC decoding circuit 470 re-applies the layered data decoding algorithm to decoder input 452 guided by decoded output 471. This continues until either a maximum number of local iterations is exceeded or decoded output 471 converges (i.e., completion of standard processing).

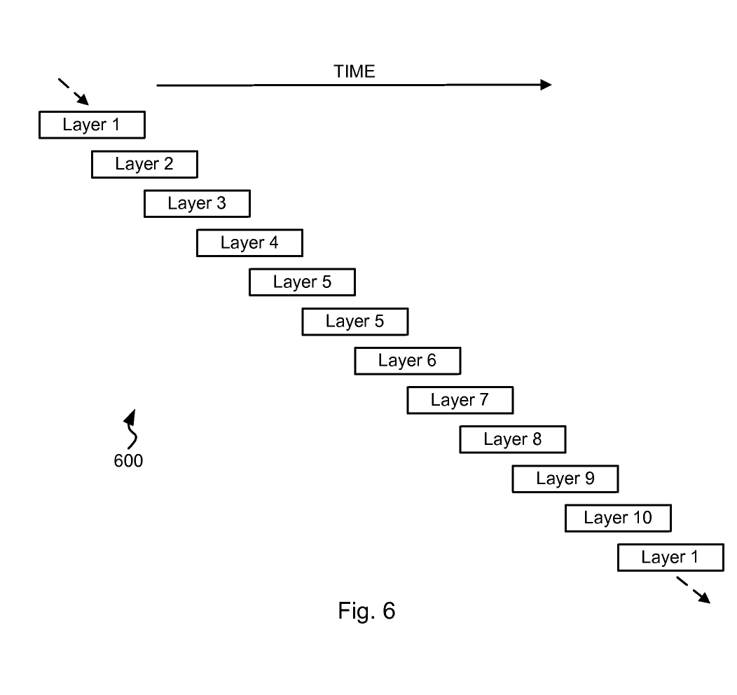

In one embodiment, a power reduced decoder scheduler circuit 479 schedules the processing of LDPC decoding circuit 470. The scheduling involves selecting the next layer to be processed whenever a layer completes processing as indicated by a layer complete signal 474, and the order in which elements of the layer are to be processed. The scheduling information is provided from power reduced decoder scheduler circuit 479 to LDPC decoding circuit 470 as a scheduling input 473. In some cases, processing of layers by LDPC decoding circuit 470 overlap. In one particular embodiment, two layers may be processing at a given time. Turning to FIG. 6, one example timing diagram 600 showing overlapping data decoder processing that may be used in relation to one or more embodiments. Timing diagram 600 shows a ten layer system (i.e., layers 1-10) where each of the layers are processed by a data decoding circuit in order. As shown, two layers are being processed during any given point in time (indicated by the line titled TIME). In particular, layer 2 starts processing before layer 1 completes, and layer three starts processing before layer 2 completes. Where two consecutive local iterations are performed, layer 1 is re-processed before the processing of layer 10 of the preceding local iteration of the data algorithm completes.

In one example of operation of power reduced decoder scheduler circuit 479 identifies a current processing layer that has been processing through LDPC decoding circuit 470 is selected as a previous layer, and the next layer is selected as the current layer as the next layer begins processing through LDPC decoding circuit 470. Using FIG. 6 as an example, before layer 2 begins processing it is selected as the current processing layer and layer 1 is selected as the previous processing layer.

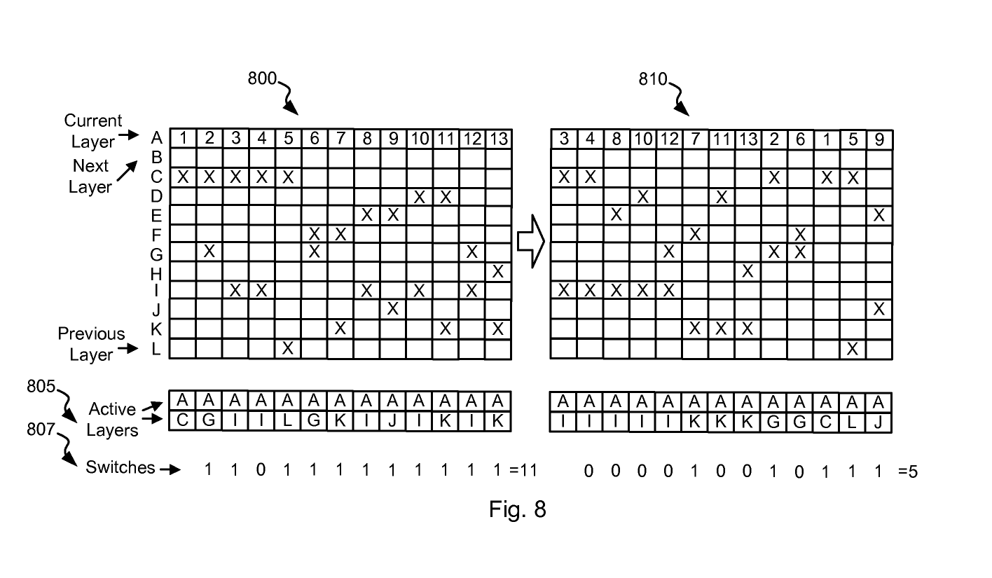

Connections between the selected current processing layer and all other layers are identified. Each of the layers include a number of elements to be processed by application of the data decoding algorithm and processing each of the elements may require access to elements from other layers within the data set being processed by the data decoding algorithm. In some cases, the elements are circulants as are known in the art. In one particular case, when processing circulants for a currently processing layer, corresponding messages (e.g., check node to variable node messages or variable node to check node messages) are accessed from other layers. Turning to FIG. 8, a number of layers (i.e., layers A-L) 800. The elements of the current processing layer are labeled 1-13, and the connections in each of the other layers required to complete processing of the corresponding element in the currently processing layer is marked with an ‘X’. Thus, as shown in layers 800, when element 1 of layer A is to be processed, element 1 of layer C (shown in active layers 805) is accessed due to the connection marked ‘X’; when element 2 of layer A is to be processed, element 2 of layer G (shown in active layers 805) is accessed due to the connection marked ‘X’; when element 3 of layer A is to be processed, element 3 of layer I is accessed (shown in active layers 805) due to the connection marked ‘X’; when element 4 of layer A is to be processed, element 4 of layer I is accessed (shown in active layers 805) due to the connection marked ‘X’; when element 5 of layer A is to be processed, element 5 of layer L is accessed (shown in active layers 805) due to the connection marked ‘X’; when element 6 of layer A is to be processed, element 6 of layer G is accessed (shown in active layers 805) due to the connection marked ‘X’; when element 7 of layer A is to be processed, element 7 of layer K is accessed (shown in active layers 805) due to the connection marked ‘X’; when element 8 of layer A is to be processed, element 8 of layer I is accessed (shown in active layers 805) due to the connection marked ‘X’; when element 9 of layer A is to be processed, element 9 of layer J is accessed (shown in active layers 805) due to the connection marked ‘X’; when element 10 of layer A is to be processed, element 10 of layer I is accessed (shown in active layers 805) due to the connection marked ‘X’; when element 11 of layer A is to be processed, element 11 of layer K is accessed (shown in active layers 805) due to the connection marked ‘X’; when element 12 of layer A is to be processed, element 12 of layer I is accessed (shown in active layers 805) due to the connection marked ‘X’; and when element 13 of layer A is to be processed, element 13 of layer K is accessed (shown in active layers 805) due to the connection marked ‘X’. Of note, while the example of FIG. 8 is shown as including thirteen (13) elements and twelve (12) layers, one of ordinary skill in the art will recognize other numbers of elements per layer and other numbers of layers that may be processed as part of a data decoding algorithm. As shown in FIG. 8, a number of switches 807 are shown as each element of layer A is processed. The number of switches 807 indicates the number of layers that are newly accessed to process the particular element of layer A. As an example, when processing element 1 of layer A, layers A and C are accessed, and when processing element 2 of layer A, layers A and G are accessed. This is a change of one layer (i.e., one switch) between element 1 of layer A and element 2 of layer A. As another example, when processing element 3 of layer A, layers A and I are accessed. This is a change of one layer (i.e., one switch) between element 2 of layer A and element 3 of layer A. Where such layers as stored in respective memories, a switch implies applying power to the memories involved in processing the given element where such switching increases power usage by the data decoding circuit. As shown, without rearranging the order in which elements of layer A are processed, the processing involves sixteen (11) switches.

Power reduced decoder scheduling circuit 479 identifies one of the other layers (i.e., a layer other than the current layer) that exhibits the most connections with the current layer. Using FIG. 8 as an example, layer I of layers 800 exhibits the largest number of connections to layer A, and either can be chosen. Elements of the chosen layer that are connected to the current layer are grouped together by power reduced decoder scheduling circuit 479, and elements within the grouped set to yield an updated grouped set. Using layers 810 of FIG. 8 as an example, elements 3, 4, 8, 10, 12 are grouped together at the beginning of the current layer.

Power reduced decoder scheduling circuit 479 determines whether there are any elements of the current layer that have not yet been included in the updated group data set. Following the example in FIG. 8, elements 1-2, 5-7, 9, 11 and 13 have not yet been included in the updated grouped data set (at this juncture including elements 3, 4, 8, 10, 12 of layer A). Where additional elements remain, the additional elements are similarly reordered until layers 810 of FIG. 8 are achieved. With this ordering in place, power reduced decoder scheduling circuit 479 fixes the order and causes LDPC data decoding circuit 470 to apply the data decoding algorithm to elements of the current layer in the re-ordered (e.g., the order of layers 810) order. As shown in active layers 805 and switches 807 corresponding to layers 810, the number of switches 807 is reduced to five (5) from sixteen (11). This reduction in the number of switches reduces the power usage of the data decoding circuit.

Where decoded output 471 fails to converge (i.e., fails to yield the originally written data set) and a number of local iterations through LDPC decoding circuit 470 exceeds a threshold, but an allowable number of global iterations is not yet exceeded, the resulting decoded output is provided as a decoded output 454 back to central memory circuit 450 where it is stored awaiting another global iteration through a data detector circuit included in data detector circuit 430. Prior to storage of decoded output 454 to central memory circuit 450, decoded output 454 is globally de-interleaved to yield a globally de-interleaved output 488 that is stored to central memory circuit 450. The global de-interleaving reverses the global interleaving earlier applied to stored codeword 486 to yield decoder input 452. When a data detector circuit included in data detector circuit 430 becomes available, a previously stored de-interleaved output 488 is accessed from central memory circuit 450 and locally de-interleaved by a de-interleaver circuit 444. De-interleaver circuit 444 re-arranges decoder output 448 to reverse the shuffling originally performed by interleaver circuit 442. A resulting de-interleaved output 497 is provided to data detector circuit 430 where it is used to guide subsequent detection of a corresponding data set previously received as equalized output 425.

Alternatively, where the decoded output converges (i.e., yields the originally written data set), the resulting decoded output is provided as an output codeword 472 to a de-interleaver circuit 480 that rearranges the data to reverse both the global and local interleaving applied to the data to yield a de-interleaved output 482. De-interleaved output 482 is provided to a hard decision buffer circuit 428 buffers de-interleaved output 482 as it is transferred to the requesting host as a hard decision output 429.

As yet another alternative, where decoded output 471 fails to converge (i.e., fails to yield the originally written data set), a number of local iterations through LDPC decoding circuit 470 exceeds a threshold, and a number of global iterations through data detector circuit 430 and LDPC data decoding circuit 470 exceeds a threshold, the result of the last pass through LDPC decoding circuit 470 is provided as a decoded output along with an error indicator (not shown). It should be noted that power reduced decoder scheduler circuit 479 may also group elements of the current layer with connections to the previous layer toward the end of processing for the current layer to avoid latency similar to that discussed below in relation to FIG. 9.

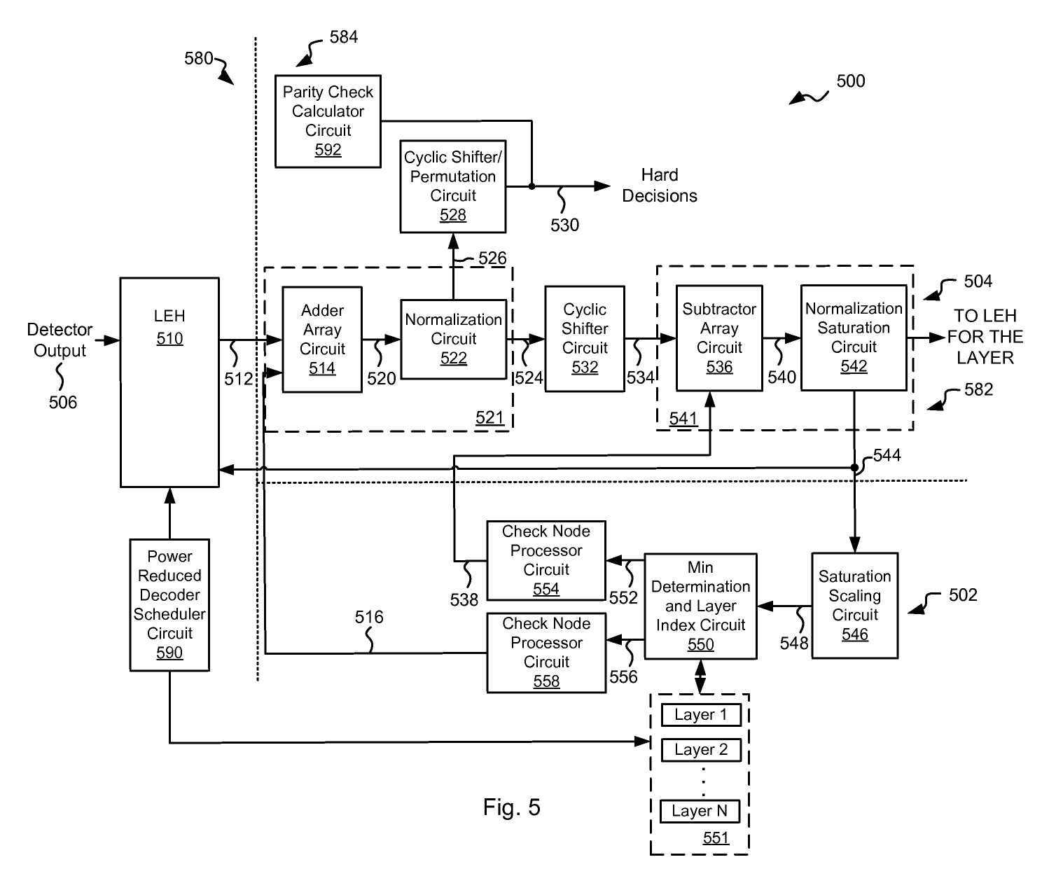

Turning to FIG. 5, a block diagram of a multi-level LDPC layer decoder 500 with layer re-ordering in accordance with various embodiments. Multi-level LDPC layer decoder 500 may be used in place of the combination of data decoding circuit 470 and power reduced decoder scheduler circuit 479 discussed above in relation to FIG. 4. Multi-level LDPC layer decoder 500 generates C2V (check node to variable node) messages from a check node processor 502 to a variable node processor 504 including a VNU 521 and a VNU 541 both shown in dashed lines using min-sum based check node calculations. Incoming LLR values for a detector output to be decoded are received as an input 506 and stored in a memory (LEH 510). LEH 510 stores the circulants that are connected with the current layer as they are updated. In addition, a min finder circuit 550 includes a layer register 551 where each layer (labeled Layer 1, Layer 2, . . . Layer N) is maintained while the decoding process is underway. Each of the layers within min finder circuit 550 are individually accessible. When switching between layers switching power is required to access the new layer. Thus, by reducing the number of layer switches, a power reduction may be achievable. A power reduced decoder scheduler circuit 590 performs the function of power reduced decoder scheduler circuit 479 discussed above in relation to FIG. 4, and as such controls the order to accesses to layers in layer register 551. Power reduced decoder scheduler circuit 590 is operable to schedule elements of the currently processing layer to reduce switching similar to that discussed below in relation to FIG. 7. In some cases, power reduced decoder scheduler circuit 590 is operable to schedule elements of the currently processing layer to both reduce switching and reduce processing latency similar to that discussed below in relation to FIG. 9. In addition, power reduced decoder scheduler circuit 590 selects the order in which the individual layers of an input data set are presented to the data decoding circuit.

LEH 510 yields stored Q values 512 or Qn(a) for the previous layers to the layer currently being processed, also referred to herein as the previous layer and the connected layer. An adder array circuit 514 adds Q values 512 to previous layer C2V messages 516 or R_{1,n}(a) in array fashion to produce S messages 520 or Sn(a) containing total soft LLR values for the previous layer.

S messages 520 are provided to a normalization and permutation circuit 522, which converts the format of the S messages 520 from four soft LLR values to the equivalent content but different format of one hard decision and three soft LLR values (for a GF(4) embodiment), and which applies a permutation to rearrange the variable node updated values to prepare for the check node update and to apply the permutations specified by the non-zero elements of the H matrix. For example, in a GF(4) embodiment, the four elements 0-3 of the Galois Field are 0, 1, α, α². The permutation applied by normalization and permutation circuit 522 is multiplication in the Galois Field. Element 2 (α) multiplied by element 1 (1) equals α×1 or α, which is element 2. Similarly, element 2×2=α×α=α², which is element 3. Element 2×3=α×α²=1, which is element 1. Thus, element 2 multiplied by 1, 2 and 3 results in elements 2, 3, and 1, which are permutations of elements 1, 2 and 3. The normalization and permutation circuit 522 yields P messages 524 or Pn(a) for the previous layer. Normalization and permutation circuit 522 also yields soft LLR values 526 which are provided to a cyclic shifter 528. Cyclic shifter circuit 528 rearranges the soft LLR values 526 to column order, performs a barrel shift which shifts the normalized soft LLR values 526 from the previous layer to the current layer using the permutation specified by the H matrix, and which yields hard decisions 530 or aₙ*, calculated as argminₐ Sₙ(a).

A parity check calculator 592 calculates parity checks based on the hard decisions 530, using any suitable technique. An example of the parity check calculations is provided in U.S. Pat. No. 8,656,249 filed on Sep. 7, 2011 for a “Multi-Level LDPC Layer Decoder” by Chen et al., which is incorporated by reference herein for all purposes. Parity check calculator 592 may calculate the parity checks on input data from LEH 510 before any local decoding iterations, or in other words, before any V2C (variable node to check node) or C2V messages are calculated in decoder 500.

P messages 524 from normalization and permutation circuit 522 are also provided to a shifter 532, a cyclic shifter or barrel shifter which shifts the symbol values in the normalized LLR P messages 524 to generate the next circulant sub-matrix, yielding current level P messages 534 which contain the total soft LLR values of the current layer. Current level P messages 534 are provided to a subtractor array 536 which subtracts the current layer C2V messages 538, or R_{2,n}(a), from the current level P messages 534, yielding D messages 540, or Dₙ(a).

D messages 540 are provided to a normalization and saturation circuit 542 which converts the format of the D messages 540 from four soft LLR values to the equivalent content but different format of one hard decision and three soft LLR values, yielding new Q messages 544, or Q_{2,n}(a), also referred to as V2C messages, for the current layer. Normalization and saturation circuit 542 also reduces the bit width of the Q messages 544, for example changing from 6-bit data words in section 582 of the decoder 500 to 5-bit data words to be stored in LEH 510 in section 580.

Q messages 544 are stored in LEH 510, overwriting previous channel or calculated values for the current layer, and are also provided to a scaler and saturation circuit 546 which scales the Q messages 544 to yield scaled V2C messages 548, or T_{2,n}(a), and which lowers the bit-width further, for example to 4-bit data words to be used in section 584 of the decoder 500. The saturation functions used to lower the bit-width between sections 582 and 584 may be performed in multiple steps as shown, for example reducing from 6-bit words to 5-bit words in normalization and saturation circuit 542 and then from 5-bit words to 4-bit words in scaler and saturation circuit 546, or may be performed in separate single steps, for example reducing from 6-bit words to 5-bit words in normalization and saturation circuit 542 for storage in LEH 510 and reducing from 6-bit words to 4-bit words in scaler and saturation circuit 546 for use in section 584. Note that the bit-width of data words is increased in adder array circuit 514, which adds 5-bit words from LEH 510 to 4-bit words and yielding 6-bit S messages 520.

In some embodiments, V2C messages 548 are provided to min finder circuit 550 which calculates the minimum value min1(d), second or next minimum value min2(d) and the index of the minimum value idx(d). Min finder circuit 550 also calculates the signs of the V2C messages 548 and tracks the sign value of each non-zero element of the H matrix and the cumulative sign for the current layer. Min finder circuit 550 yields the current layer minimum, next minimum and index values with the sign values 552 to a previous layer C2V generator 554, which calculates the current layer C2V messages 538, or R_{2,n}(a). Min finder circuit 550 also yields the previous layer minimum, next minimum and index values with sign values 556 to a current layer C2V generator 558, which calculates the previous layer C2V messages 516, or R_{1,n}(a). Previous layer C2V generator 554 and current layer C2V generator 558 generate the C2V or R messages 538 and 516 based on the final state and current column index of the symbol. If the current column index is equal to the index of the minimum value, then the value of R is the second minimum value. Otherwise, the value of R is the minimum value of that layer. The sign of R is the XOR of the cumulative sign and the current sign of the symbol.

In summary, the variable node processor 504 and the check node processor 502 operate together to perform layered decoding of non-binary or multi-level data. Variable node processor 504 generates variable node to check node messages (V2C messages) and calculates perceived values based on check node to variable node messages (C2V messages). Check node processor 502 generates C2V messages and calculates checksums based on V2C messages, using a min finder circuit operable to identify a minimum, a next minimum and an index of minimum value in the V2C messages.

The saturation function applied in normalization and saturation circuit 542 and in scaler and saturation circuit 546 may be used in various embodiments to reduce bit-width from any source width to any target width. In the example embodiments disclosed herein, normalization and saturation circuit 542 and in scaler and saturation circuit 546 may be used to reduce the bitwidth of a data word from 6 bits to 5 bits, from 6 bits to 4 bits, and from 5 bits to 4 bits.

Turning to FIG. 7, a flow diagram 700 shows a method in accordance with one or more embodiment for limiting layer switching as part of a data decoding algorithm. Following flow diagram 700, a current processing layer that has been processing through a data decoding circuit is selected as a previous layer (block 705), the next layer is selected as the current layer as the next layer begins processing through the data decoding circuit (block 710). Using FIG. 6 as an example, before layer 2 begins processing it is selected as the current processing layer and layer 1 is selected as the previous processing layer.

Connections between the selected current processing layer and all other layers are identified (block 715). Each of the layers include a number of elements to be processed by application of the data decoding algorithm and processing each of the elements may require access to elements from other layers within the data set being processed by the data decoding algorithm. In some cases, the elements are circulants as are known in the art. In one particular case, when processing circulants for a currently processing layer, corresponding messages (e.g., check node to variable node messages or variable node to check node messages) are accessed from other layers.

Turning to FIG. 8, a number of layers (i.e., layers A-L) 800. The elements of the current processing layer are labeled 1-13, and the connections in each of the other layers required to complete processing of the corresponding element in the currently processing layer is marked with an ‘X’. Thus, as shown in layers 800, when element 1 of layer A is to be processed, element 1 of layer C (shown in active layers 805) is accessed due to the connection marked ‘X’; when element 2 of layer A is to be processed, element 2 of layer G (shown in active layers 805) is accessed due to the connection marked ‘X’; when element 3 of layer A is to be processed, element 3 of layer I is accessed (shown in active layers 805) due to the connection marked ‘X’; when element 4 of layer A is to be processed, element 4 of layer I is accessed (shown in active layers 805) due to the connection marked ‘X’; when element 5 of layer A is to be processed, element 5 of layer L is accessed (shown in active layers 805) due to the connection marked ‘X’; when element 6 of layer A is to be processed, element 6 of layer G is accessed (shown in active layers 805) due to the connection marked ‘X’; when element 7 of layer A is to be processed, element 7 of layer K is accessed (shown in active layers 805) due to the connection marked ‘X’; when element 8 of layer A is to be processed, element 8 of layer I is accessed (shown in active layers 805) due to the connection marked ‘X’; when element 9 of layer A is to be processed, element 9 of layer J is accessed (shown in active layers 805) due to the connection marked ‘X’; when element 10 of layer A is to be processed, element 10 of layer I is accessed (shown in active layers 805) due to the connection marked ‘X’; when element 11 of layer A is to be processed, element 11 of layer K is accessed (shown in active layers 805) due to the connection marked ‘X’; when element 12 of layer A is to be processed, element 12 of layer I is accessed (shown in active layers 805) due to the connection marked ‘X’; and when element 13 of layer A is to be processed, element 13 of layer K is accessed (shown in active layers 805) due to the connection marked ‘X’. Of note, while the example of FIG. 8 is shown as including thirteen (13) elements and twelve (12) layers, one of ordinary skill in the art will recognize other numbers of elements per layer and other numbers of layers that may be processed as part of a data decoding algorithm. As shown in FIG. 8, a number of switches 807 are shown as each element of layer A is processed. The number of switches 807 indicates the number of layers that are newly accessed to process the particular element of layer A. As an example, when processing element 1 of layer A, layers A and C are accessed, and when processing element 2 of layer A, layers A and G are accessed. This is a change of one layer (i.e., one switch) between element 1 of layer A and element 2 of layer A. As another example, when processing element 3 of layer A, layers A and I are accessed. This is a change of one layer (i.e., one switch) between element 2 of layer A and element 3 of layer A. Where such layers as stored in respective memories, a switch implies applying power to the memories involved in processing the given element where such switching increases power usage by the data decoding circuit. As shown, without rearranging the order in which elements of layer A are processed, the processing involves sixteen (11) switches.

Power reduced decoder scheduling circuit 479 identifies one of the other layers (i.e., a layer other than the current layer) that exhibits the most connections with the current layer. Using FIG. 8 as an example, layer I of layers 800 exhibits the largest number of connections to layer A, and either can be chosen. Elements of the chosen layer that are connected to the current layer are grouped together by power reduced decoder scheduling circuit 479, and elements within the grouped set to yield an updated grouped set. Using layers 810 of FIG. 8 as an example, elements 3, 4, 8, 10, 12 are grouped together at the beginning of the current layer.

Returning again to FIG. 7, one of the other layers (i.e., a layer other than the current layer) that exhibits the most connections with the current layer is identified (block 720). Using FIG. 8 as an example, layer I and layer C of layers 800 exhibit the largest number of connections to layer A, and either can be chosen. Elements of the chosen layer that are connected to the current layer are grouped together to yield a grouped set (block 725). Using layers 810 of FIG. 8 as an example, elements 3, 4, 8, 10, 12 are grouped together at the beginning of the current layer.

Returning to FIG. 7, it is determined whether there are any elements of the current layer that have not yet been included in the updated group data set (block 740). Following the example in FIG. 8, elements 1-2, 5-7, 9, 11 and 13 have not yet been included in the updated grouped data set (at this juncture including elements 3, 4, 8, 10, 12 of layer A). Where additional elements remain, the processes of blocks 720-740 are repeated. This processing repeats until the layers 810 of FIG. 8 are achieved. Once all of the elements have been incorporated in the updated group set (block 740), the order of the updated group set is fixed (block 745). The layered data decoding algorithm is then applied by the data decoding circuit to the updated grouped set (block 750). As shown in active layers 805 and switches 807 corresponding to layers 810, the number of switches 807 is reduced to thirteen (13) from sixteen (16). This reduction in the number of switches reduces the power usage of the data decoding circuit.

Turning to FIG. 9, a flow diagram 900 shows a method in accordance with some embodiments for limiting layer switching as part of a data decoding algorithm. Flow diagram 900 is similar to flow diagram 700, except that processing elements with connections in the previous layer is forced to happen a the end of processing regardless of switches. As shown in FIG. 6, data from the previous layer is still ongoing when the next layer begins processing. By forcing processing of elements with connections to the previous layer to be done at the end, the previous layer is allowed to finish before the next layer processes elements with connections to the previous layer. By doing this, processing latency due to waiting for an element in the previous layer to complete processing before a connected element in a current layer is processed is avoided.

Following flow diagram 900, a current processing layer that has been processing through a data decoding circuit is selected as a previous layer (block 905), the next layer is selected as the current layer as the next layer begins processing through the data decoding circuit (block 910). Using FIG. 6 as an example, before layer 2 begins processing it is selected as the current processing layer and layer 1 is selected as the previous processing layer.

Connections between the selected current processing layer and all other layers are identified (block 915). Each of the layers include a number of elements to be processed by application of the data decoding algorithm and processing each of the elements may require access to elements from other layers within the data set being processed by the data decoding algorithm. In some cases, the elements are circulants as are known in the art. In one particular case, when processing circulants for a currently processing layer, corresponding messages (e.g., check node to variable node messages or variable node to check node messages) are accessed from other layers.

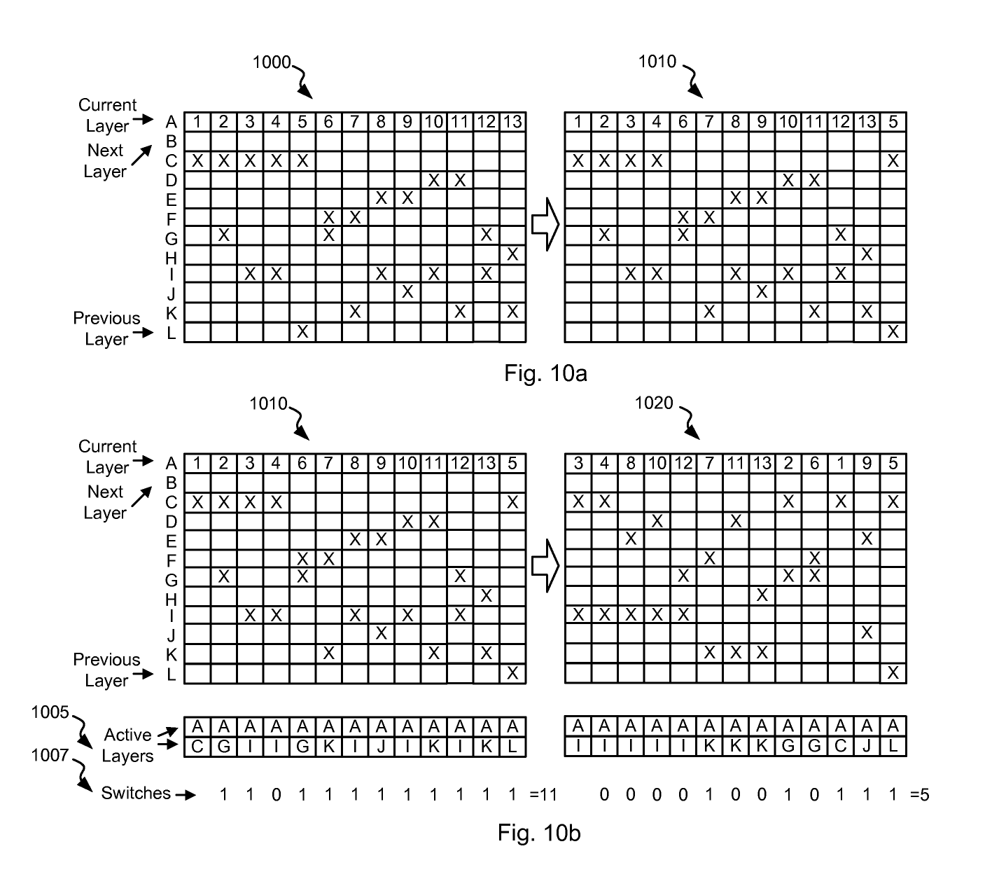

Turning to FIG. 10a, a number of layers (i.e., layers A-L) 1000. The elements of the current processing layer are labeled 1-13, and the connections in each of the other layers required to complete processing of the corresponding element in the currently processing layer is marked with an ‘X’. Thus, as shown in layers 1000, when element 1 of layer A is to be processed, element 1 of layer C (shown in active layers 1000) is accessed due to the connection marked ‘X’; when element 2 of layer A is to be processed, element 2 of layer G (shown in active layers 1000) is accessed due to the connection marked ‘X’; when element 3 of layer A is to be processed, element 3 of layer I is accessed (shown in active layers 1000) due to the connection marked ‘X’; when element 4 of layer A is to be processed, element 4 of layer I is accessed (shown in active layers 1000) due to the connection marked ‘X’; when element 5 of layer A is to be processed, element 5 of layer L is accessed (shown in active layers 1000) due to the connection marked ‘X’; when element 6 of layer A is to be processed, element 6 of layer G is accessed (shown in active layers 1000) due to the connection marked ‘X’; when element 7 of layer A is to be processed, element 7 of layer K is accessed (shown in active layers 1000) due to the connection marked ‘X’; when element 8 of layer A is to be processed, element 8 of layer I is accessed (shown in active layers 1000) due to the connection marked ‘X’; when element 9 of layer A is to be processed, element 9 of layer J is accessed (shown in active layers 1000) due to the connection marked ‘X’; when element 10 of layer A is to be processed, element 10 of layer I is accessed (shown in active layers 1000) due to the connection marked ‘X’; when element 11 of layer A is to be processed, element 11 of layer K is accessed (shown in active layers 1000) due to the connection marked ‘X’; when element 12 of layer A is to be processed, element 12 of layer I is accessed (shown in active layers 1000) due to the connection marked ‘X’; and when element 13 of layer A is to be processed, element 13 of layer K is accessed (shown in active layers 1000) due to the connection marked ‘X’.

Returning again to FIG. 9, connections between elements of the current layer and elements of the previous layer are identified (block 960). Using layers 1000 as an example, element 5 of the previous layer is connected with the corresponding elements in the current layer. Processing of the connected elements in the previous layer are grouped at the end of a grouped set (block 965), and the elements of the grouped set are arranged to limit switching (block 970). Turning to FIG. 10a again, layers 1010 show an example result of the processes of blocks 960-970 where element 5 is placed for processing at the end of processing elements 1-13 of layer A.

One of the other layers (i.e., a layer other than the current layer) that exhibits the most connections with the current layer is identified (block 925). Using FIG. 10b as an example, layer I of layers 1010 exhibit the largest number of connections to layer A. Elements of the chosen layer that are connected to the current layer are grouped together to yield a grouped set (block 930). Using layers 1020 of FIG. 10b as an example, elements 3, 4, 8, 10, 12 are grouped together at the beginning of the current layer.

It is determined whether there are any elements of the current layer that have not yet been included in the updated group data set (block 940). Following the example in FIG. 10b, elements 1-2, 6-7, 9, 11 and 13 (5 is forced to be at the end) have not yet been included in the updated grouped data set. Where additional elements remain, the processes of blocks 920-940 are repeated.

Once all of the elements have been incorporated in the updated group set (block 940), the order of the updated group set is fixed (block 945). The layered data decoding algorithm is then applied by the data decoding circuit to the updated grouped set (block 950). As shown in active layers 1005 and switches 1007 corresponding to layers 1020, the number of switches 1007 is reduced to fourteen (14) from thirteen (13). This reduction in the number of switches reduces the power usage of the data decoding circuit.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for decoding a data set, the system comprising:
a layered data decoder circuit operable to apply a data decoding algorithm to a data input to yield a decoded output, wherein the data input includes a group of input elements; and
a scheduler circuit operable to:
identify layer based connections between individual elements of the group of input elements;
assemble a first subset of the group of input elements that share a first set of layer based connections to yield a first processing group;
assemble a second subset of the group of input elements that share a second set of layer based connections to yield a second processing group; and
provide a layered processing order, wherein the layered processing order includes the first processing group being processed by the layered data decoder circuit before the second processing group is processed by the layered data decoder circuit.

2. The system of claim 1, wherein the layered processing order limits switching between layers during application of the data decoding algorithm.

3. The system of claim 3, wherein limiting switching between layers during application of the data decoding algorithm reduces power consumption by the layered data decoder circuit.

4. The system of claim 1, wherein the group of input elements is a group of circulants, wherein the first subset of the group of input elements is a first subset of the group of circulants, and wherein the second subset of the group of input elements is a second subset of the group of circulants.

5. The system of claim 4, wherein the first subset of the group of circulants exhibits connections to a first previously processed layer, and wherein the second subset of the group of circulants exhibits connections to a second previously processed layer.

6. The system of claim 4, wherein the first subset of the group of circulants does not exhibit any connections to a previously processed layer, and wherein the second subset of the group of circulants exhibits connections to the previously processed layer.

7. The system of claim 1, wherein the system is implemented as part of a device selected from a group consisting of: a storage device, and a communication device.

8. The system of claim 1, wherein the layered data decoder circuit comprises:
a variable node processor; and
a check node processor.

9. The system of claim 1, wherein the data decoding algorithm is a low density parity check decoding algorithm.

10. The system of claim 1, wherein the system is implemented as part of an integrated circuit.

11. A method for decoding a data set, the method comprising:
providing a layered data decoder circuit operable to apply a data decoding algorithm to a data input to yield a decoded output, wherein the data input includes a group of input elements;
identifying layer based connections between individual elements of the group of input elements;
assembling a first subset of the group of input elements that share a first set of layer based connections to yield a first processing group;
assembling a second subset of the group of input elements that share a second set of layer based connections to yield a second processing group; and
applying the data decoding algorithm by the data decoder circuit such that the first processing group is processed by the layered data decoder circuit before the second processing group is processed by the layered data decoder circuit.

12. The method of claim 11, wherein applying the data decoding algorithm by the data decoder circuit such that the first processing group is processed by the layered data decoder circuit before the second processing group is processed by the layered data decoder circuit limits switching between layers during application of the data decoding algorithm.

13. The method of claim 12, wherein limiting switching between layers during application of the data decoding algorithm reduces power consumption by the layered data decoder circuit.

14. The method of claim 11, wherein the group of input elements is a group of circulants, wherein the first subset of the group of input elements is a first subset of the group of circulants, and wherein the second subset of the group of input elements is a second subset of the group of circulants.

15. The method of claim 14, wherein the first subset of the group of circulants exhibits connections to a first previously processed layer, and wherein the second subset of the group of circulants exhibits connections to a second previously processed layer.

16. The method of claim 14, wherein the first subset of the group of circulants does not exhibit any connections to a previously processed layer, and wherein the second subset of the group of circulants exhibits connections to the previously processed layer.

17. The method of claim 11, wherein the layered data decoder circuit comprises:
a variable node processor; and
a check node processor

18. The method of claim 11, wherein the data decoding algorithm is a low density parity check decoding algorithm.

19. A storage device, the storage device comprising:
a storage medium;
a data detector circuit operable to apply a data detection algorithm to a data input to yield a detected output, wherein the data input is derived from information accessed from the storage medium;
a layered data decoder circuit operable to apply a data decoding algorithm to a data input to yield a decoded output, wherein the data input includes a group of input elements; and
a scheduler circuit operable to:
identify layer based connections between individual elements of the group of input elements;
assemble a first subset of the group of input elements that share a first set of layer based connections to yield a first processing group;
assemble a second subset of the group of input elements that share a second set of layer based connections to yield a second processing group; and
provide a layered processing order, wherein the layered processing order includes the first processing group being processed by the layered data decoder circuit before the second processing group is processed by the layered data decoder circuit.

20. The storage device of claim 19, wherein the layered processing order limits switching between layers during application of the data decoding algorithm.
